(19) United States
(12) Patent Application Publication
(10) Pub. No.: US 2026/0152685 A1
(43) Pub. Date: Jun. 4, 2026

(54) 3D Nanoarchitectured Hexagonal Boron Nitride with Integrated Single Photon Emitters

(71) Applicant: THE JOHNS HOPKINS UNIVERSITY, Baltimore, MD (US)

(72) Inventors: Mingwei CHEN, Cockeysville, MD (US); Christopher Florencio ALEMAN, Baltimore, MD (US)

(21) Appl. No.: 18/964,815

(22) Filed: Dec. 2, 2024

Related U.S. Application Data
(60) Provisional application No. 63/606,345, filed on Dec. 5, 2023.

(51) Int. Cl. C09K 11/63; C01B 21/064; C09K 11/02; C09K 11/08

(52) U.S. Cl. CPC C09K 11/63; C01B 21/0648; C09K 11/02; C09K 11/0883; C01P 2002/76; C01P 2002/82; C01P 2004/03; C01P 2006/16; C01P 2006/60

(57) ABSTRACT

Three-dimensional (3D) nanoarchitectured hexagonal boron nitride (hBN) is described with integrated solid-state single photon emitters (SPEs) from native defects generated during high-temperature chemical vapor deposition (CVD). The 3D hBN has a quasi-periodic gyroid minimal surface structure and is composed of a continuous 3D hBN sheet with built-in convex and concave curvatures that promote the formation of optically active and thermally robust native defects. The free-standing feature of the gyroid hBN with a nearly zero mean curvature can effectively eliminate the substrate disturbance and minimize lattice strain heterogeneity. As a result, naturally occurring defects with a narrow SPE spectral distribution can be created and activated as color centers in the 3D hBN, and the density of the SPEs can be tailored by CVD temperature.

### CROSS-REFERENCE TO RELATED APPLICATIONS

This application claims the benefit of U.S. Provisional Patent Application No. 63/606,345, filed on Dec. 5, 2023, which is incorporated by reference.

### STATEMENT OF GOVERNMENT INTEREST

This invention was made with government support under Grant Numbers DMR 1804320 and DMR 2327777 awarded by the National Science Foundation. The government has certain rights in the invention.

### TECHNICAL FIELD

The present teachings relate generally to three-dimensional nanoarchitectured hexagonal boron nitride and, more particularly, to integrated single photon emitters within three-dimensional nanoarchitectured hexagonal boron nitride.

### BACKGROUND

The versatility of two-dimensional hexagonal boron nitride (2D hBN) with a wide bandgap has expanded over the last decade. Especially, photonic and optoelectronic applications have been demonstrated across the electromagnetic spectrum from UV to IR and, most notably, hBN is capable of hosting spectrally stable single photon emitters (SPEs) that possess megahertz count rates up to 800K for room- and high-temperature quantum technologies such as quantum sensing, quantum communication, and quantum computing. Despite 2D hBN having a wide bandgap of ˜6.0 eV, the quantum emissions are in the visible light range, originating from deep center defects, i.e. atomic-scale point defects such as impurities, vacancies and vacancy complexes. These defects generate highly localized electronic states which are confined to a region on the scale of a single lattice constant and are well isolated within the wide band gap of hBN. While the exact structural origins of SPEs in 2D hBN are still debated, the features of atomic- and nano-scale thinness and the planar surface enable efficient modulation of its properties and facile access to emitters. The near-surface nature of the defects with an in-plane dipole results in out-of-plane emissions and circumvents the issue of total internal or Fresnel reflection encountered by bulk solid-state emitters such as nitrogen vacancy centers in diamond. The wide band gap of hBN also prevents nonradiative decay for a high quantum efficiency up to 87%. Recently, SPEs have been demonstrated on a variety of 2D hBN platforms which were fabricated by top-down and bottom-up methods and created via post processing treatments such as ion and electron irradiations, thermal annealing, plasma etching, and mechanical straining.

However, similar to other van der Waals materials, the 2D nature of hBN SPEs also entails challenges for technological applications. For example, the surface nature of the defect-based color centers is susceptible to environmental influences and, as a result, the color centers often show broad spectral variability as seen from zero phonon lines spanning from the deep ultraviolet to the near infrared, which is beyond the spectral range that is possibly tuned by the Stark effect and mechanical strain engineering. The large spectral variability, which is caused by substrate disturbance, strain heterogeneity, defect variation, phonon dephasing and trapped charges, fundamentally limits the implementation of hBN SPEs in quantum technologies which require photon indistinguishability. Therefore, developing substrate-free and strain-homogeneous 2D hBN is of interest for achieving hBN SPEs with a narrow spectral distribution and high purity.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A single photon emitter is disclosed, that includes a three-dimensional nanoporous sheet which can include hexagonal boron nitride, a plurality of convex curvatures, and a plurality of concave curvatures, and where one or more radii of curvatures of the plurality of convex curvatures are from about 50 nm to about 300 nm, and one or more radii of curvatures of the plurality of convex curvatures are from about 50 nm to about 300 nm. Implementations of the single photon emitter can include where the three-dimensional nanoporous sheet is from about 10 to about 50 microns thick. One or more lateral dimensions of the three-dimensional nanoporous sheet are from about 5 cm to about 50 cm. A g²(τ) value of the three-dimensional nanoporous sheet is 0.06 or less. The three-dimensional nanoporous sheet, as characterized by E_{2g} Raman spectroscopy, has a full width at half maximum (FWHM) distribution peak at 15 cm⁻¹. A mean curvature of the plurality of convex curvatures and the plurality of convex curvatures is zero. The three-dimensional nanoporous sheet is substrate-free.

A method for preparing a three-dimensional nanoporous sheet is disclosed. The method for preparing a three-dimensional nanoporous sheet includes providing an alloyed substrate, may include an alloy of a first metal and a second metal. The method for preparing a three-dimensional nanoporous sheet also includes dealloying the alloyed substrate to selectively remove the second metal from the alloyed substrate to create a dealloyed substrate. The method for preparing a three-dimensional nanoporous sheet also includes pre-annealing the dealloyed substrate. The method also includes growing a layer of hexagonal boron nitride onto one or more internal and external surfaces of the dealloyed substrate. The method also includes etching away the dealloyed substrate to provide a hexagonal boron nitride (hBN) three-dimensional nanoporous sheet. Implementations of the method for preparing a three-dimensional nanoporous sheet include where the first metal is nickel (Ni); the second metal is manganese (Mn); and the second metal is removed from the alloyed substrate using a selective dealloying solution based on a difference in chemical potential between the second metal and the first metal. Dealloying the alloyed substrate further may include exposing the alloyed substrate to a 1 m solution of (NH₄)₂SO₄ solution. The second metal is copper (Cu). The method for preparing a three-dimensional nanoporous sheet may include stabilizing the dealloyed substrate with a solution coating of a polymer. The polymer may include polymethyl methacrylate (PMMA). Growing a layer of hexagonal boron nitride onto one or more internal and external surfaces of the dealloyed substrate may include chemical vapor deposition (CVD) at a temperature from about 1000° C. to about 1050° C. One or more lateral dimensions of the hexagonal boron nitride (hBN) three-dimensional nanoporous sheet are from about 5 cm to about 50 cm. The hexagonal boron nitride (hBN) three-dimensional nanoporous sheet is from about 10 to about 50 microns thick. A g²(τ) value of the hexagonal boron nitride (hBN) three-dimensional nanoporous sheet is 0.06 or less. The hexagonal boron nitride (hBN) three-dimensional nanoporous sheet, as characterized by E_{2g} Raman spectroscopy, has a full width at half maximum (FWHM) distribution peak at 15 cm⁻¹. The hexagonal boron nitride (hBN) three-dimensional nanoporous sheet is a single photon emitter. The hexagonal boron nitride (hBN) three-dimensional nanoporous sheet may include a plurality of convex curvatures, and a plurality of concave curvatures; and where one or more radii of curvatures of the plurality of convex curvatures are from about 50 nm to about 300 nm, one or more radii of curvatures of the plurality of convex curvatures are from about 50 nm to about 300 nm, and a mean curvature of the plurality of convex curvatures and the plurality of convex curvatures is zero.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1C illustrate a model of a quasi-periodic gyroid minimal surface structure, a scanning electron microscope (SEM) micrograph of as-synthesized 3D nanoporous hBN. The inset is the photo of the substrate-free 3D nanoporous hBN with a width of 0.5 cm, and a schematic diagram of a synthesis procedure of 3D nanoporous hBN, including chemical vapor deposition of 3D nanoporous hBN with a pseudo-periodic minimal surface structure, respectively, in accordance with the present disclosure.

FIGS. 2A-2D depict a high resolution transmission electron microscope (TEM) analysis of 3D np-hBN, including a TEM micrograph of 3D np-hBN demonstrating clear lattice sites, with an inset showing the correlated electron diffraction pattern with sharp diffraction spots indicating high crystallinity, magnified images of several regions of FIG. 2A, superimposed with the lattice models of hBN, showing a perfect honeycomb lattice in FIG. 2B and a nitrogen vacancy in FIG. 2C, and a TEM electron energy loss spectrum (EELS) of the 3D nanoporous hBN in FIG. 2D, in accordance with the present disclosure.

FIGS. 3A-3F depict several plots showing Raman spectroscopy measurements of 3D hBN. FIG. 3A is a representative Raman spectra of np-hBN@Ni and substrate-free np-hBN grown at 1050° C. In the measurements, the np-hBN@Ni samples usually have a poorer S/N ratio and lower Raman intensity, likely from the interference from the Ni substrates. FIG. 3B shows a Raman E_{2g} peak shift with interrogated sites in the hBN deposited on Ni at 1050° C. FIG. 3C depicts a Raman peak distribution of np-hBN@Ni samples fabricated at 1000° C. vs those fabricated at 1050° C. FIG. 3D depicts Raman peak distributions of np-hBN@Ni and substrate-free np-hBN.

FIG. 3E illustrates FWHM distribution of np-hBN@Ni samples fabricated at 1000° C. vs those fabricated at 1050° C., and FIG. 3F depicts FWHM distributions of Raman peaks of np-hBN@Ni vs substrate-free np-hBN, in accordance with the present disclosure.

FIGS. 4A-4C depict measurements depicting representative zero phonon lines (ZPLs) and phonon side bands (PSBs) from substrate-bound and substrate-free np-hBN deposited at 1050° C., in accordance with the present disclosure.

FIGS. 5A and 5B are a fluorescence map and a plot depicting g (2) measurements of 3D hBN at room temperature, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

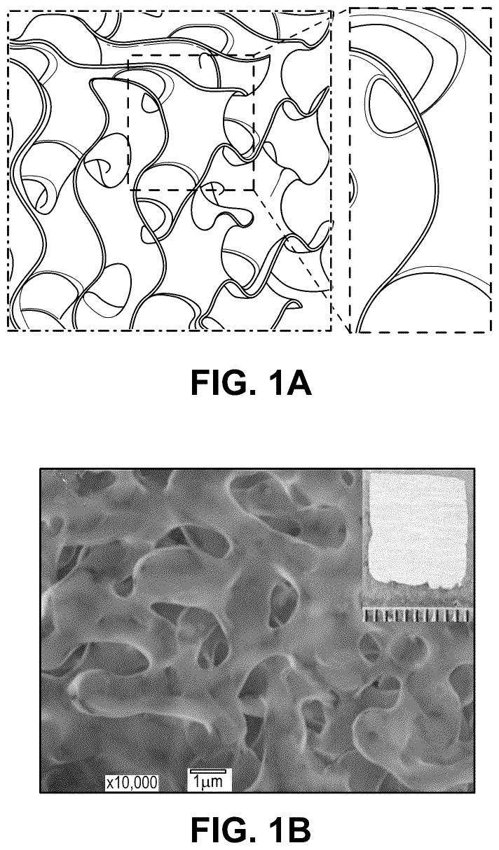

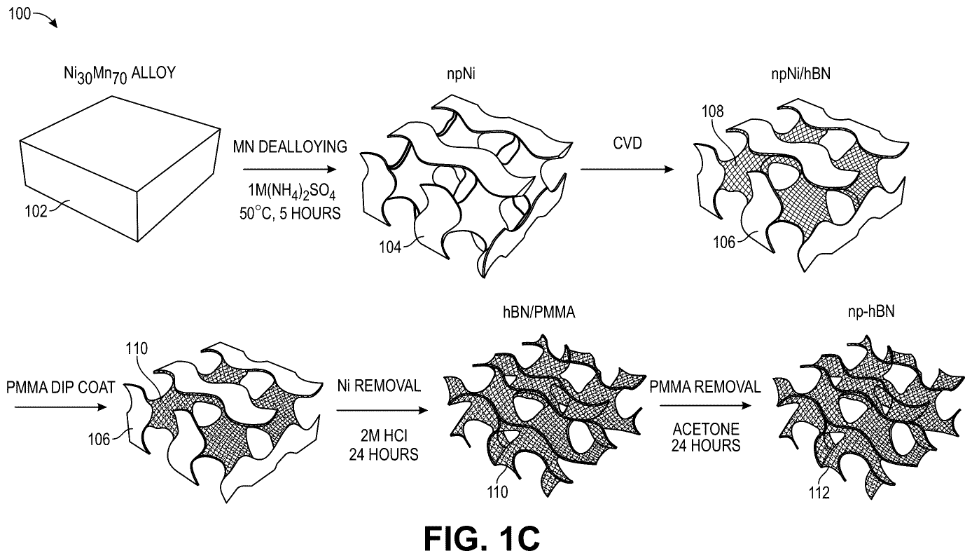

The present disclosure provides a method to assemble 2D hBN as a substrate-free 3D architecture that can retain the unique 2D properties of hBN and eliminate the substrate disturbance. Several methods have been developed previously to fabricate 3D hBN, such as freeze drying, critical point drying, chemical vapor deposition (CVD) on Ni foams and carbon aerogel templates, and solid-state reactions. These 3D porous hBN materials can address the challenge of scalability and impart an extensive list of attractive new properties for a wide range of applications benefiting from their high surface area, large pore volume and low mass density. However, none of the previously explored methods have been found to host SPEs for quantum emissions, most likely due to uncontrollable structural heterogeneity and complex landscape of crystal defects in these 3D hBN. The present disclosure provides a demonstration of quantum emissions from robust native defects in 3D nanoporous hBN (np-hBN) with a pseudo-periodic gyroid minimal surface structure, as shown in FIG. 1A. The substrate-free hBN SPEs with minimized strain heterogeneity show a narrow ZPL distribution and a tunable SPE density for potential quantum device applications.

In examples, while polymethyl methacrylate (PMMA) can be used in the methods as described to create a freestanding template for the 3D nanoporous hBN (np-hBN), other polymers may also be used, as long as they provide support and are removable as described herein in reference to the PMMA. In other examples, copper may be used instead of nickel. Additional alloys that can be utilized for fabricating 3D porous subtracts for 3D h-BN growth include Ni—Mn, Ni—Zn, Ni—Mg, Cu—Mn, Cu—Zn, and combinations thereof. Copper (Cu), nickel (Ni), manganese (Mn), magnesium (Mg), zinc (Zn) combinations are particularly suitable for this application. While examples using an alloy of Ni₃₀Mn₇₀ is used in examples of the present disclosure, the ratio of Ni to Mn, or of a first metal to a second metal is 30:70, which controls the porosity and can provide a stable template for fabrication of a nanoporous 3D sheet, other ratios, such as from about 10:90 to about 80:20 of a first metal to a second metal. Such 3D continuously porous architecture with minimal surfaces can be fabricated using the methods and materials as described herein. These provide a hexagonal boron nitride having a porosity where a mean curvature of the boron nitride architecture is zero.

Previously known single photon emitters based on 3D architecture use a single flat monolayer or only a few layers. Structures of the present disclosure are fabricated in bulk with the dimensions dependent on the application but can be on the order of 10 to about 200 microns, or from about 20 to about 50 microns or from about 20 to about 30 microns thick. Single photo emitters of the present disclosure have an atom missing from the lattice where the vacancy occurs and that is where the SPE effect occurs.

FIGS. 1A-1C illustrate a model of a quasi-periodic gyroid minimal surface structure, a scanning electron microscope (SEM) micrograph of as-synthesized 3D nanoporous hBN. The inset is the photo of the substrate-free 3D nanoporous hBN with a width of 0.5 cm, and a schematic diagram of a synthesis procedure of 3D nanoporous hBN, including chemical vapor deposition of 3D nanoporous hBN with a pseudo-periodic minimal surface structure, respectively, in accordance with the present disclosure. FIGS. 1A and 1B illustrate a structure model and scanning electron microscope (SEM) micrograph of the 3D np-hBN, respectively. The substrate-free np-hBN includes interconnected open pore channels constructed by a 3D continuous hBN sheet with the co-existence of both convex and concave curvatures. The feature radii of the curvatures are about hundreds of nanometers and the mean curvature at each point of hBN is approximately zero. The quasi-periodic gyroid minimal surface topology is adopted from a nanoporous Ni (np-Ni) substrate that is produced by surface-diffusion-mediated self-assembly during dealloying of a Ni₃₀Mn₇₀ alloy. In contrast to conventional chemical etching to prepare porous substrates from two-phase mixtures, the dealloying is an atomic-scale self-assembly process. Driven by chemical potential difference between Ni and Mn in 1M (NH₄)₂SO₄ solution, Mn atoms are selectively removed from the random Ni₃₀Mn₇₀ solid solution, while the remaining Ni reorganizes by surface diffusion to form a bicontinuous structure. As the surface energy is the key factor for the stability of the bicontinuous structure, the self-assembly naturally picks up the minimal surface structure to minimize the total energy. Experimentally, the gyroid minimal surface structure of dealloyed metals has been previously demonstrated by electron tomography as evidenced by the co-existence of positive and negative curvatures and the nearly zero mean curvature. When the dealloyed samples are annealed at high temperatures, the feature length of the bicontinuous gyroid structure becomes coarsened but the overall topological configuration remain unchanged. The fabrication process 100 of the 3D np-hBN, illustrated schematically in FIG. 1C, includes three essential steps: preparation of the np-Ni template by chemically dealloying centimeter-sized Ni₃₀Mn₇₀ sheets 102; pre-annealing the dealloyed np-Ni templates 104 in forming gas atmosphere to stabilize the porous structure and the subsequent CVD growth of hBN 108 on the internal surface 106 of np-Ni; dip coating in PMMA 110, and isolation of free-standing 3D np-hBN by etching away the np-Ni template 104. This is followed by subsequent removal of the PMMA 110 using acetone immersion for 24 hours. The inset included in FIG. 1B is an optical photo of a substrate-free np-hBN. The free-standing 3D hBN 112 has a white color, similar to 2D hBN nanosheets, from the wide band gap. As the gaseous precursors of hBN can diffuse into deep pores of np-Ni templates during high-temperature CVD, the np-Ni based CVD method is capable of fabricating a large size 3D porous hBN with the lateral dimensions up to tens of centimeters for direct device applications without the requirements of assembly and support.

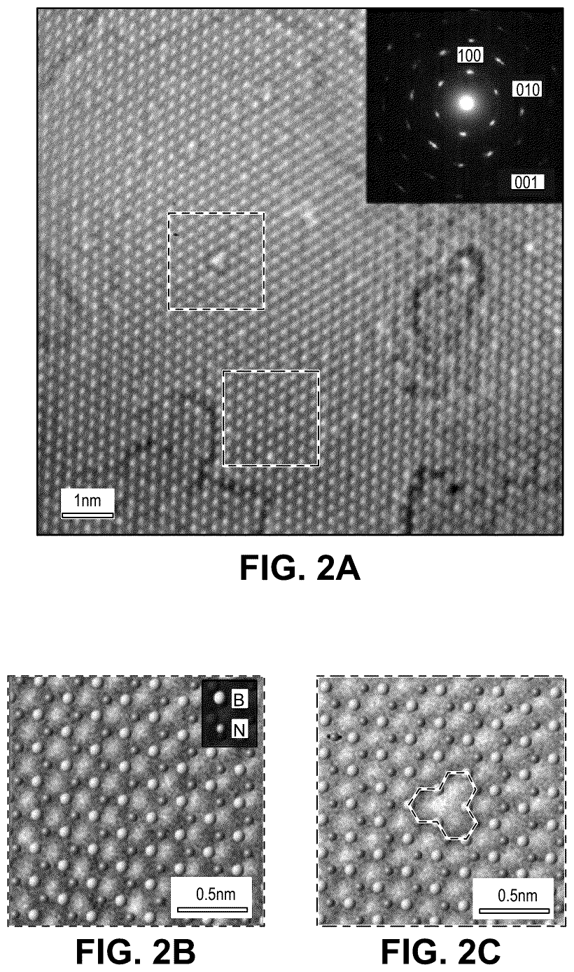

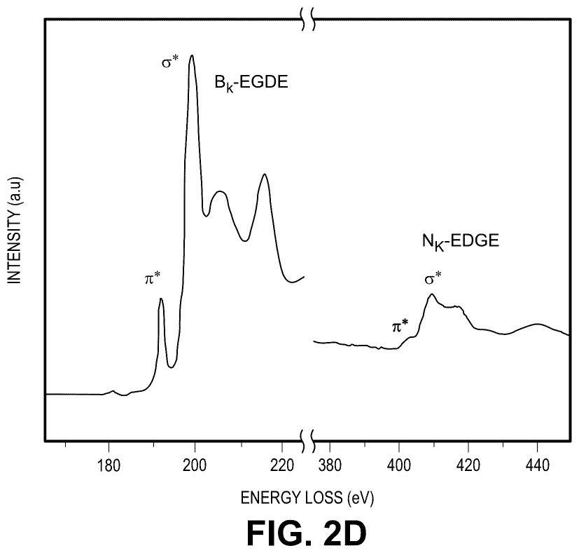

FIGS. 2A-2D depict a high resolution transmission electron microscope (TEM) analysis of 3D np-hBN, including a TEM micrograph of 3D np-hBN demonstrating clear lattice sites, with an inset showing the correlated electron diffraction pattern with sharp diffraction spots indicating high crystallinity, magnified images of several regions of FIG. 2A, superimposed with the lattice models of hBN, showing a perfect honeycomb lattice in FIG. 2B and a nitrogen vacancy in FIG. 2C, and a TEM electron energy loss spectrum (EELS) of the 3D nanoporous hBN in FIG. 2D, in accordance with the present disclosure. The structure and chemistry of the CVD-grown hBN were further inspected by transmission electron microscopy (TEM) and electron energy-loss spectroscopy (EELS). FIG. 2A is a high-resolution TEM (HRTEM) image taken from the free-standing 3D hBN grown at 1050° C., in which a well-defined crystal lattice with a low density of crystal defects can be observed. A magnified image, FIG. 2B unveils the B-N honeycomb structure, isostructural to graphene. Occasionally, point defects, most like boron vacancies, can be observed in the sample, as shown in FIG. 2C. As the TEM was operated under a low dose mode, these vacancies should not be produced by electron beam damage but are likely the native defects that are generated during high-temperature CVD. The inset of FIG. 2A is the selected area electron diffraction (SAED) pattern from a large area of the sample using a 500 nm diameter selected area aperture. The sharp diffraction spots are well consistent with the clear lattice image and affirm that that the sample has high crystallinity. In the TEM EELS spectra of FIG. 2D, both B and N k-edges have the obvious π edges, demonstrating that the B and N atoms, arranged in the honeycomb structure and have the sp₂-hybridized bonding state. Quantitative EELS analysis also verifies that the boron to nitrogen ratio is ˜1:1, close to the stoichiometry of hBN.

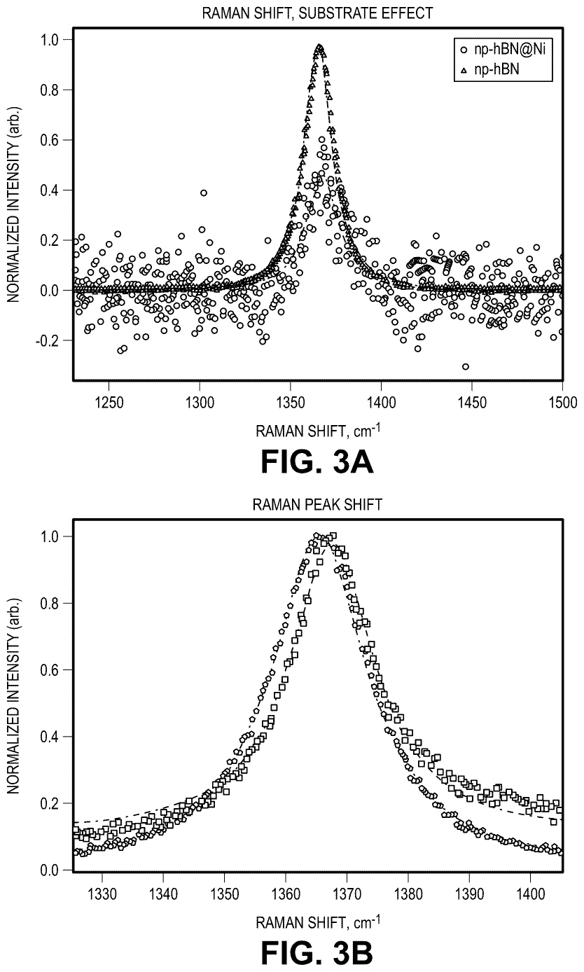

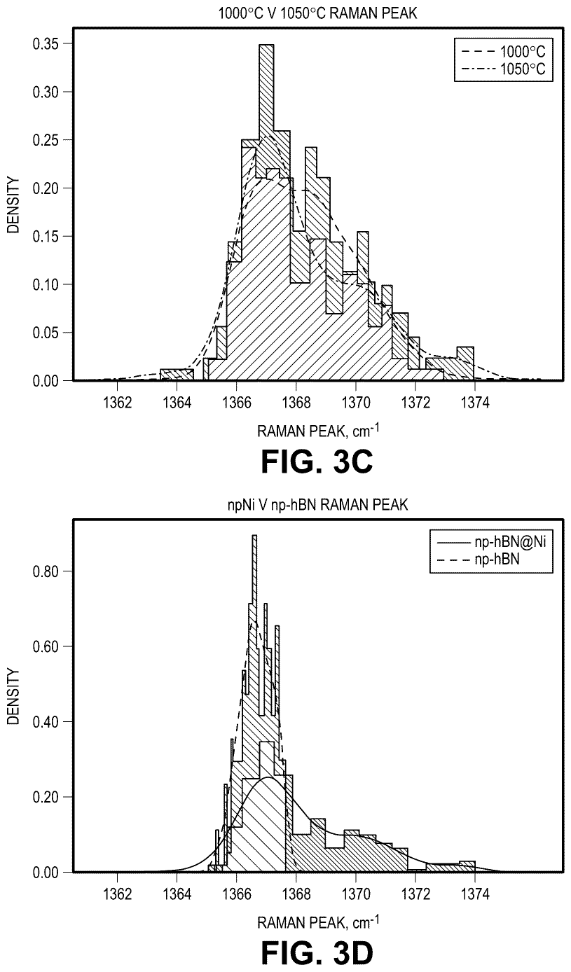

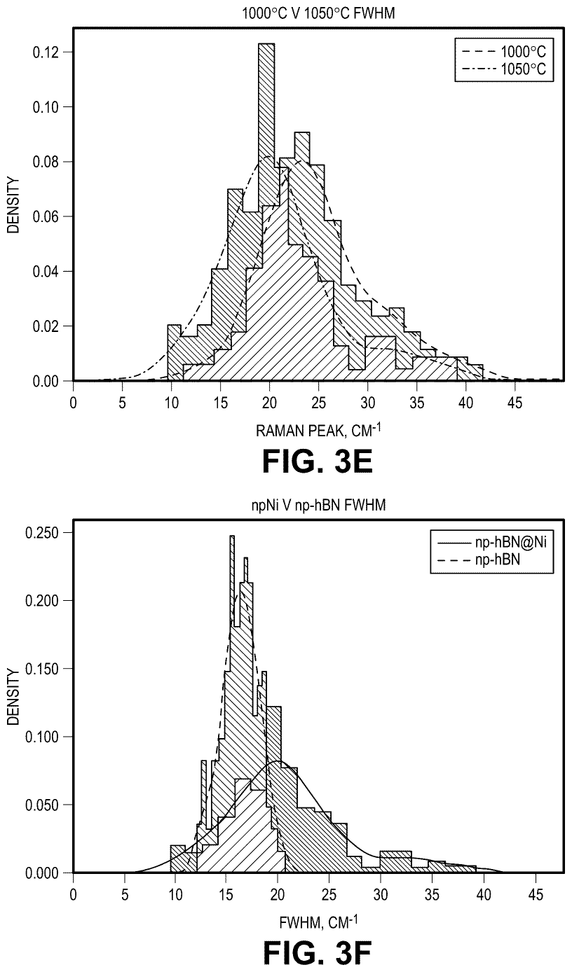

FIGS. 3A-3F depict several plots showing Raman spectroscopy measurements of 3D hBN. FIG. 3A is a representative Raman spectra of np-hBN@Ni and substrate-free np-hBN grown at 1050° C. In the measurements, the np-hBN@Ni samples usually have a poorer S/N ratio and lower Raman intensity, likely from the interference from the Ni substrates. FIG. 3B shows a Raman E_{2g} peak shift with interrogated sites in the hBN deposited on Ni at 1050° C. FIG. 3C depicts a Raman peak distribution of np-hBN@Ni samples fabricated at 1000° C. vs those fabricated at 1050° C. FIG. 3D depicts Raman peak distributions of np-hBN@Ni and substrate-free np-hBN. FIG. 3E illustrates FWHM distribution of np-hBN@Ni samples fabricated at 1000° C. vs those fabricated at 1050° C., and FIG. 3F depicts FWHM distributions of Raman peaks of np-hBN@Ni vs substrate-free np-hBN, in accordance with the present disclosure. The structure of np-hBN was also characterized by Raman spectroscopy with a 532 nm CW laser. Representative Raman spectra of np-hBN with and without a np-Ni substrate, grown at 1050° C., are shown in FIG. 3A. For hBN, only the in-plane, zone-centered and counterphase vibrational mode, termed E_{2g}, is Raman active. The E_{2g} phonon modes are observed from both samples. The sharp E_{2g} Raman peaks demonstrate the high crystallinity of the CVD-grown 3D hBN and rule out the possible formation of amorphous boron nitride, highly-defective hBN and cubic boron nitride,^{[60-62]} which is consistent with the TEM observations in FIG. 2. However, the np-hBN@Ni samples have a relatively lower signal-to-noise (S/N) ratio and lower Raman intensity in comparison with the substrate-free ones. For the samples with np-Ni substrates, it was observed that there are obvious Raman peak shifts with the changes of interrogated sites (FIG. 3B), which is most likely associated with microstructural heterogeneity and inhomogeneous strain distribution imposed by the np-Ni substrate.

To comprehensively describe the structure of the as-deposited hBN with Ni substrates, Raman spectra were randomly recorded across the samples to illustrate the stochastic distribution of the hBN E_{2g} band. FIG. 3C depicts a histogram of the Raman peak centers collected from 213 sites of the samples fabricated at 1000° C. and 159 sites of the samples produced at 1050° C. The Raman peaks extracted from the 1000° C. samples yield a distribution ranging from 1364.9 to 1373.0 cm⁻¹ with the average occurring at 1368.2 cm⁻¹ and a standard deviation of 1.7 cm⁻¹. Similarly, the 1050° C. deposition logs values from 1363.4 to 1374.0 cm⁻¹ with the average occurring at 1368.1 cm⁻¹ and a standard deviation of 2.0 cm⁻¹. The distributions of the E_{2g} bands appear to be bimodal with such characteristics more acutely pronounced at 1050° C. The E_{2g} band of bulk hBN crystals is located at ˜1366 cm⁻¹ and redshifts with the decrease of hBN layer number and in-plane strain. Thus, it is possible that the slightly broader distribution of the E_{2g} mode in the 1050° C. samples originates from relatively thinner hBN layers as a higher CVD temperature leads to the formation of thinner hBN. It has been previously demonstrated that substrate-supported mono-, bi- and tri-layer hBN post Raman peak values of 1369.6±0.6 cm⁻¹, 1369.0±0.5 cm⁻¹, and 1367.5±0.2 cm⁻¹, respectively. Similarly, others have recorded the values of mono-, bi-, tri-, and 4-layer hBN at 1370.5±0.8 cm⁻¹, 1370.0±0.6 cm⁻¹, 1367.8±0.4 cm⁻¹, and 1367.2±0.4 cm⁻¹. These redshifts from the bulk E_{2g} value of ˜1366 cm⁻¹ are associated with in-plane strains of the atomically thin hBN nanosheets as their flexibility accommodates the surface roughness of substrates. Compared to these results, the large redshifts presenting in the samples shown herein can be attributed to the strain and strain heterogeneity imposed by the np-Ni substrates, together with the built-in curvatures of the minimal surface structure. Moreover, from the wide distribution of Raman peak center values of the present samples, it can be deduced that the 3D hBN samples may be composed of mono- to multi-layer hBN, with few-layer hBN being the primary constituent. This is inferred from the susceptibility of thin hBN layers to strain, which is reflected in the shift of the E_{2g} value. Previous studies suggested that uniaxial strain leads to the Raman peak splitting due to lattice symmetry breaking. A study on bubbles in hBN experimentally demonstrated the emergence of an additional peak appears between 1320-1340 cm⁻¹ corresponding to a strain-softened E_{2g} mode. However, due to the lack of peak splitting and the emergence of the additional peak as seen in hBN bubbles across all of the present Raman data, it can be speculated that the strains imparted by the np-Ni substrate with the minimal surface structure could be effectively biaxial whereby the relevant components of the shear deformation are nullified and the lattice symmetry is preserved.

To determine the influence of Ni substrates on the Raman band shift, substrate-free np-hBN were prepared by exfoliating the np-Ni substrates and compared the Raman data statistics with that of the substrate-bound np-hBN deposited at 1050° C. In general, the substrate-free np-hBN shows a higher E_{2g} band intensity and more symmetric peak shape (FIG. 3A). As previously noted, the np-Ni bound hBN deposited at 1050° C. logs Raman peak values between 1363.4 and 1374.0 cm⁻¹ with the average occurring at 1368.1 cm⁻¹ and a standard deviation of 2.0 cm⁻¹. After removing the Ni substrates, this range narrows to 1365.3-1367.7 cm⁻¹ with the average occurring at 1366.7 cm⁻¹ and a small standard deviation of 0.5 cm⁻¹ (FIG. 3D). The narrowing of the distribution and the blueshift of the average are in line with previous reports of suspended hBN. It has also been found that the Raman peak distribution of the substrate-free hBN assumes a normal character, in contrast to the bimodal nature that was found on the substrate-bound hBN. Consequently, Ni substrates significantly influence the Raman spectrum of 3D np-hBN, similar to the 2D hBN on planar substrates. It should be noted that substrate-free np-hBN has the average Raman frequency close to the bulk value of strain-free hBN. In fact, this observation is consistent with the features of the minimal surface structure of np-hBN, i.e. the net mean curvature is zero and the elastic energy of lattice strains is minimized.

The influence of the Ni substrates can also be observed from the full width at half maximum (FWHM) of the Raman E_{2g} peaks of np-hBN, which can be extrapolated to demonstrate the crystallinity and lattice perfectness of 2D hBN. The FWHM distributions of the substrate-bound np-hBN deposited at 1000° C. and 1050° C. are plotted in FIG. 3E and the distributions of the substrate-free np-hBN and substrate-bound np-hBN deposited at 1050° C. in FIG. 3F. The FWHM of the substrate-bound 1000° C. deposition posts values ranging from 11.3-41.8 cm⁻¹ and an average of 25.0 cm⁻¹ with a standard deviation of 5.7 cm⁻¹; the substrate-bound 1050° C. deposition logs the FWHM values from 9.5 to 39.2 cm⁻¹ with an average of 20.9 cm⁻¹ and a standard deviation of 5.8 cm⁻¹. Lastly, the FWHMs of the substrate-free np-hBN deposited at 1050° C. range from 12.8-20.8 cm⁻¹ with an average of 16.3 cm⁻¹ and a standard deviation of 1.8 cm⁻¹, which are significantly smaller than these substrate-bound ones.

The line shape of the FWHM distributions closely resembles that of their Raman peak counterparts such that both the substrate-bound distributions are approximately bimodal and the substrate-free np-hBN distributions are normal (FIG. 3F). The change from a bimodal to normal distributions after the np-Ni substrates are removed, again, demonstrates that the Ni substrates significantly enlarge the lattice distortions and strain heterogeneity of np-hBN. Minute differences are noted between the line shapes of the FWHM distributions in the substrate-bound depositions at 1000° C. and 1050° C., but note that the average of the 1050° C. sample is lower than the 1000° C. deposited one (FIG. 3E), hinting that a higher CVD temperature could have an obvious impact on crystallinity and defect formation of the deposited hBN.

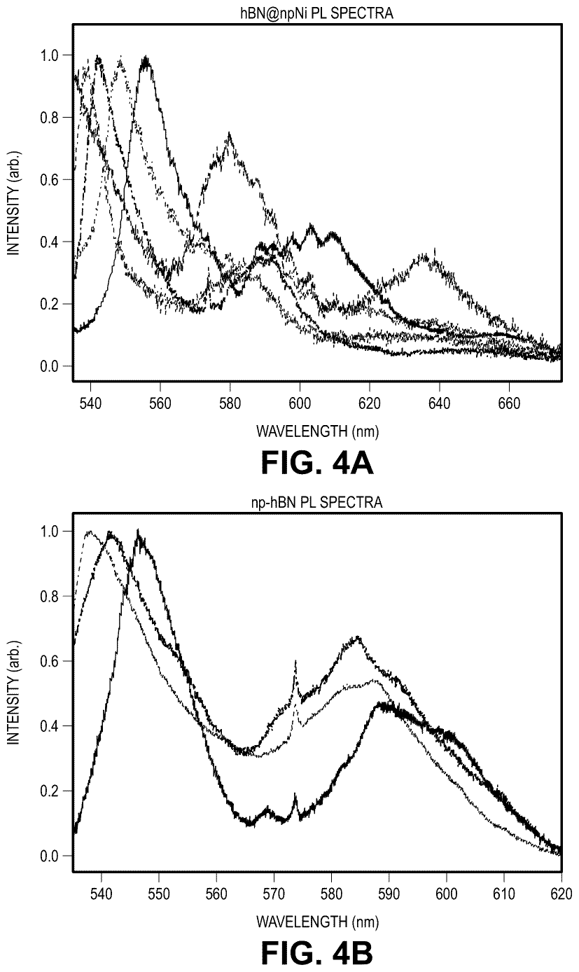

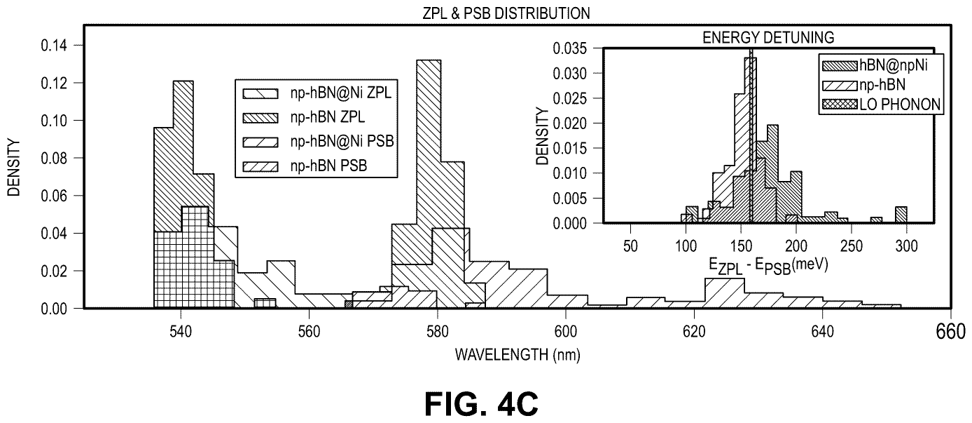

Characterization of Light Emissions via Photoluminescence Spectroscopy are shown and described in regard to FIGS. 4A-4C. FIGS. 4A-4C depict measurements depicting representative zero phonon lines (ZPLs) and phonon side bands (PSBs) from substrate-bound and substrate-free np-hBN deposited at 1050° C., in accordance with the present disclosure. FIG. 4A depicts PL spectra of five different measurements from the substrate-bound np-hBN@Ni emitters. The spectral line of each emitter has been plotted in a different color for clarity. FIG. 4B shows spectral lines from substrate-free np-hBN. Each emitter has been plotted in a different color for clarity. FIG. 4C depicts distribution of ZPLs and PSBs for substrate-bound and substrate-free hBN.

Photoluminescence (PL) measurements with a 532 nm CW laser at room temperature reveal the possible formation of single photon emitters in the 3D hBN samples deposited at 1050° C., as evidenced by the frequent appearance of emission peaks around 540-560 nm which have previously been ascribed to quantum emissions from the deep center defects in the wide-band hBN. In contrast, such light emissions are rarely observed from the samples deposited at 1000° C. despite of the fact that there is only 50° C. difference in the CVD temperature and all other CVD parameters remain unchanged. Both zero phonon lines (ZPLs) and phonon side bands (PSBs) from the trap state can be frequently detected when stochastic scans of the 1050° C. samples are conducted with and without np-Ni substrates (FIGS. 4A and 4B). Unlike previous efforts in the field, post-treatments, such as annealing and focus ion beam fabrication, are not needed to activate the light emitters which are created during high-temperature CVD and are intrinsically active. The PL spectra of ZPLs show a typical asymmetric line shape due to the PSBs being adjacent to the ZPLs. The ZPLs of the substrate-bound samples (FIG. 4A), distributed between ˜535 and ˜580 nm, which is in the spectral regime that hBN SPEs are deterministically created by localized deformation using Si nanopillars. As the energy of a ZPL is determined primarily by the Hamiltonian describing the orbital component of the defect wave function, the broad distribution of the ZPLs from the substrate-bound 3D hBN could be caused by the shift of the orbital excited-to-ground-state splitting by defect-to-defect variations in heterogeneous strain fields.

Similar to the Raman results, the np-Ni substrates also significantly influence the PL of hBN. After exfoliation of np-Ni substrates, the ZPLs fall in a smaller spectral range but have insignificant changes in FWHM in comparison with that of the substrate-bound samples (FIG. 4B). The distribution of the ZPLs, measured by stochastic scans, reduces to a very narrow range of 535-550 nm as shown in FIG. 4C, which is comparable to and even better than those of reported 2D flat hBN. The narrow spectral distribution of the substrate-free np-hBN further demonstrates that the Ni substrates significantly influence the optical properties of hBN and the quality of quantum emissions. The substrate effect can also be demonstrated by the detuning energy, i.e. the frequency gap between ZPL and PSB peaks. For the substrate-bound np-hBN, the average detuning energy is ˜176.5 meV while the value decreases to ˜153 meV after removing the np-Ni substrates (FIG. 4C inset). Note that the detuning energy value of the substrate-free np-hBN nearly matches the longitudinal optical phonon energy of hBN. The detuning shifting to a lower energy, together with a narrowing in the ZPL distribution, for the substrate-free samples unambiguously demonstrates that the substrates cause significant inhomogeneity in light emissions of hBN and thus spectral diffusion of ZPLs.

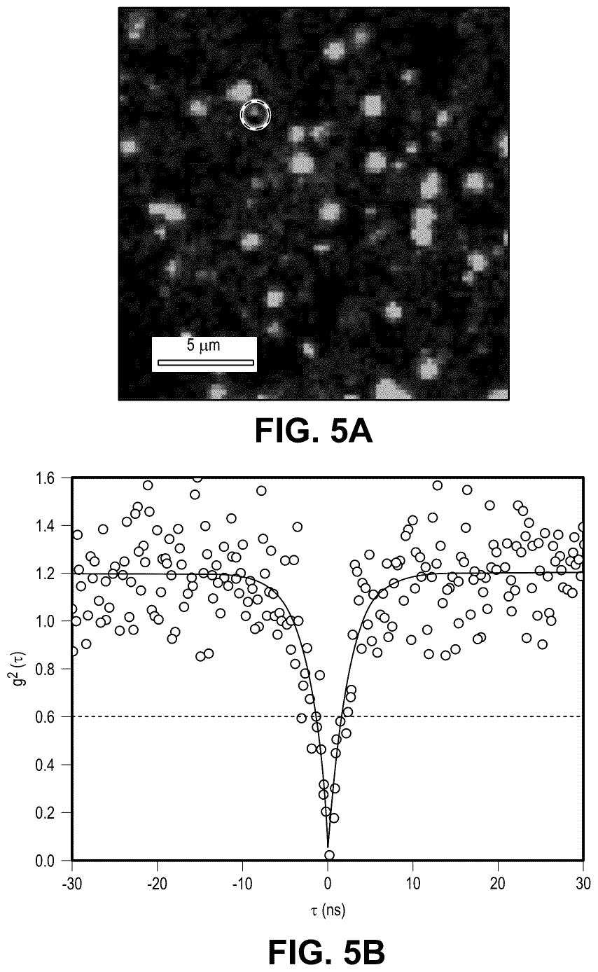

Demonstration of the quantum nature of light emissions is shown and described in regard to FIGS. 5A and 5B. FIGS. 5A and 5B are a fluorescence map and a plot depicting g⁽²⁾ measurements of 3D hBN at room temperature, in accordance with the present disclosure. FIG. 5A is a fluorescence map of np-hBN with Ni substrate showing the distribution of color centers. The emitter analyzed in FIG. 5B is circled in red. FIG. 5B depicts a g⁽²⁾ measurement (dots) and fit (line) on a single color center over a short time range obtained from the emitter circled in panel FIG. 5A. The density of the color centers in the np-hBN with the Ni substrate is illustrated by a room-temperature fluorescence map FIG. 5A, acquired by exciting with a 531 nm CW laser and collecting all light with wavelengths of 600-700 to avoid possible influence of Raman signals. The preliminary result shows a high density of emission centers in the sample fabricated at 1050° C. The larger, brighter regions correspond to clusters of multiple emitters that cannot be independently isolated and analyzed. The quantum nature of isolated emitters was verified by the presence of an antibunching dip near zero time delay in the second-order photon autocorrelation function g⁽²⁾ (τ=0) as shown in FIG. 5B. The antibunching measurements were performed using the Hanbury-Brown Twiss geometry. Due to the presence of long-lived bunching (g²(τ)>1), indicating the presence of a multi-level system, a fitting function of the following form is adopted,

$${g}^{2} ( τ ) = 1 - {ρ}^{2} [ ( 1 + a ) {e}^{- \vert τ \vert / {τ}_{1}} - {ae}^{- \vert τ \vert / {τ}_{2}} ] ,$$

where α is the photon bunching amplitude, τ is the delay time, τ_{1,2} correspond to two excited state lifetimes, and ρ accounts for an uncorrelated background. The commonly accepted threshold for an emitter to be classified as an SPE is for

$${g}^{2} ( τ = 0 ) < \frac{1}{2} ( 1 + a {ρ}^{2} ) .$$

Fitting of the data shown by the solid blue line in FIG. 5B yields values of α=0.21 and g⁽²⁾(τ=0)=0.06, well below the calculated threshold level of 0.6 (dotted line), and establishes the single photon character of the emitters in np-hBN. This measured value of g⁽²⁾(τ=0) for the 3D hBN is better than almost all values reported for 2D hBN in the literature and provides firm evidence for high quality quantum emissions from the 3D hBN. An emitter lifetime τ₁=2.33 ns is also obtained from the fit, and is consistent with SPEs reported in 2D hBN.

It is worth noting that the SPEs are created during CVD growth at a high temperature of 1050° C. and, thus, should originate from the naturally occurring defects that form during hBN growth under thermodynamic equilibrium. According to DFT calculations of the charge-state transition levels of native defects in 2D hBN, the energy distribution (˜2.32-2.25 eV) of ZPLs indicates that the defects for SPEs could be boron related point defects such as vacancies, interstitials and anti-site defects. Other models would suggest that the nitrogen vacancies and boron interstitials could be the origins of emissions centered around 540-560 nm. Moreover, point defect complexes could also act as a color center in hBN for visible light emissions. However, native vacancies, antisite defects and defect complexes in hBN all have a high formation energy above 4 eV, and, according to the Boltzmann equation, are unlikely to form in 2D hBN at 1050° C. under thermodynamic equilibrium. Self-interstitial defects, such as boron interstitials, have a relatively low formation energy below 3 eV under certain chemical environments, but the low migration barrier energies of the self-interstitial defects render them very mobile and likely to be annihilated at vacancies and step edges at the high CVD temperatures or during cooling. As lattice strain can promote the formation of crystal defects and lead to the shift of ZPL, correlating the structural origin of ZPLs in 3D np-hBN to previous reports without considering the effects of curvature may result in an erroneous conclusion. It is envisioned that the built-in curvature of the 3D hBN decreases the formation energy of optically active native defects which cannot be formed in 2D flat hBN under the same CVD growth conditions. In turn, these defects can reduce the elastic energy of a curved lattice by accommodating the built-in curvature of gyroid hBN. The geometric and topological requirements could lead to the formation of the defects with specific atomic configurations which are thermally stable and optically active. In preliminary high-resolution TEM characterization, vacancy-type defects have been observed in the 3D hBN (FIG. 2C), supporting the hypothesis that the curved lattice strains promote the formation of native vacancies that are optically active. Like other native point defects in crystals, the density and types of vacancies should depend on CVD temperature. In the present case, 1050° C. appears to be the critical temperature for the formation of optically active defects, below which the defect density is insignificant. Therefore, ZPLs appear much more frequently in the 3D hBN samples deposited at 1050° C. relative to 1000° C. In random scanning with a laser spot diameter of ˜865 nm, ZPLs can be detected from ˜75% of the randomly chosen sites in the samples grown at 1050° C. In contrast, only ˜5% of sites show the signals of ZPLs in the 1000° C. samples. Since the 50° C. difference in the CVD temperature should not induce obvious changes in the 3D microstructure (i.e., pore size, curvature and porosity) of np-hBN, the obvious difference in the number density of color centers may purely result from the temperature dependence of the optically active defect formation. In practice, the strong temperature dependence could be utilized as an important variable, combining with curvature, to tailor SPEs in 3D np-hBN.

It has been reported that SPEs in 2D hBN fabricated on flat Ni foils by low-pressure CVD at 1030° C. have noted ZPLs centered around 580 nm. In contrast, the ZPLs of the substrate-bound np-hBN are distributed in a range between 535 and 580 nm (FIG. 4A), indicating that the 3D porous structure and Ni-substrates may cause the significant spectral variability. Since the ZPLs of the substrate-bound np-hBN fall in the same spectral regime as that of 2D hBN SPEs created by localized deformation using Si nanopillars, inhomogeneous strains and strain gradients in the substrate-bound np-hBN appear to be the primary cause of the spectral variability, together with possible enhancements in light emission and absorption from the surface plasmon of the np-Ni substrates. The present data also show that the np-Ni substrates can activate more types of light emitters observed at longer wavelengths, as the emissions at those energies are not found upon the removal of the np-Ni templates, similar to previous observations from 2D hBN. In fact, this observation is in line with the bimodal distribution of the Raman E_{2g} bands of the substrate-bound np-hBN. Interestingly, after removing the np-Ni substrates, the ZPL distribution of the substrate-free np-hBN becomes very narrow in the range between 535 and 550 nm (FIG. 4C). The spectral distribution of ZPLs in the substrate-free np-hBN is comparable to and even better than those of 2D hBN. It is noted that this range could extend slightly below 535 nm as there are limitations associated with the laser's excitation wavelength. It should also be emphasized that np-hBN samples of the present disclosure are free of polymethyl methacrylate (PMMA) which was used to prepare substrate-free np-hBN. It has also been observed that spectra of the PMMA/np-hBN samples where sharp peaks associated with PMMA are visible for sites with and without optical signatures associated with defect emissions. These PMMA Raman peaks are absent for the np-hBN samples.

As no visible structural changes in the 3D porous nanoarchitecture occurs after removing the Ni substrates, it validates that the retained 3D curvature of the gyroid minimal surface structure do not cause obvious spectral diffusion of ZPLs, but the uniform lattice strain in the curved hBN results in the blueshift of ZPLs in comparison with 2D hBN. Importantly, the 3D material with a complex geometric and topological structure has a homogenous optical performance, which is consistent with the Raman characterization that the lattice strains imparted by the minimal surface curvature in the np-hBN are homogeneous with a normal distribution. The relevant components of shear deformation caused by biaxial lattice bending are nullified and lattice symmetry can be well preserved. The obvious blueshift of the ZPLs unambiguously demonstrates that a large lattice strain is imparted to the hBN lattice. The large homogeneous lattice strain may significantly influence the localized defect levels in the bandgap of hBN as up to 1 eV energy shifts can be realized by curvature alone in wrinkled 2D hBN. Since strain engineering is an important approach to stimulate and tune single-photon light sources, the minimal surface structure with built-in lattice strain and minimized strain heterogeneity could be utilized to design and manipulate the energy of photons with narrow spectral diffusion and to produce SPEs with a nearly identical straining environment for realizing photon indistinguishability. Furthermore, tailoring the feature lengths (thus curvatures) imparted by the np-Ni template remains unexplored but the variation of lattice curvatures is envisioned to result in optimal quantum emissions and unique optical properties as previously demonstrated in 3D graphene.

An integrated SPE system composed of 3D architectured hBN with a quasi-periodic gyroid minimal surface structure is described herein. The substrate-free SPEs from native defects produced by high-temperature CVD have a narrow spectral distribution, benefiting from the minimized strain heterogeneity of the minimal surface structure and the elimination of substrate disturbance. The built-in curvature of the 3D minimal surface structure promotes the formation of optically active defects, and the density of the native defects can be tailored by CVD temperature. The present teachings may pave a new way to fabricate high-quality hBN SPEs and scalable photonic nanoarchitectures necessary for a wide-range of quantum applications.

The nanoporous metal-based CVD method, employed to fabricate scalable, free-standing 3D hBN, has been established for growing 3D graphene and transition metal dichalcogenides. As illustrated in FIG. 1C, np-Ni substrates with a controllable thickness are fabricated by chemically dealloying manganese from 10-500 μm thick Ni₃₀Mn₇₀ alloy sheets using 1M (NH₄)₂SO₄ solution for 5 hours at 50° C. The as-dealloyed np-Ni has bicontinuous open porosity with a mean pore size of ˜10 nm. A single step LPCVD process is then employed where a crucible holding ammonia borane powder is placed ˜20 cm outside the entrance of the furnace and a custom holder enclosing the np-Ni is placed at the center of the furnace, approximately 50 cm downstream from the entrance. The furnace is then purged for 10 minutes at a 500/10 sccm Ar/H₂ flow rate. Afterwards, the furnace is ramped up at a heating rate of ˜22.5° C./minute to a desired temperature to anneal the np-Ni substrate. The pore sizes (thus curvatures) of the np-Ni are tuned by annealing between 800° C.-1000° C. in an 1500/60 sccm Ar/H₂ atmosphere. This annealing procedure results the coarsening of nanopores from as-dealloyed 10 nm to ˜1 μm in mean pore size as illustrated by SEM (FIG. 1B). Following the annealing, the furnace is ramped up to the designated CVD temperatures of 1000° C. or 1050° C. at a rate of 10° C./min. Upon reaching the desired CVD temperatures, the Ar/H₂ flow rates are lowered to 1000/40 sccm, respectively, and the ammonium borane powder is heated to 75° C. using an external heating band for 25 minutes such that the precursor vapor is introduced into the CVD chamber, converts into polyborazylene, diffuses through the pore channels of the np-Ni template, and ultimately yields atomically thin layers of hBN by cross-linking and dehydrogenating. Upon completing the deposition, the furnace is opened and fan cooled for rapid quenching. After removing the samples from the CVD chamber, they are then immersed in a 3.0 wt % PMMA in anisole solution overnight after which the samples are cured at 120° C. for 1 hour. Then, the samples are transferred to a 2M HCl solution for 24 hours to dissolve the Ni templates before exchanging the HCl solution for deionized water for another 24 hours. Finally, the samples are immersed in an acetone for 24 hours to remove the PMMA.

Microstructural and optical characterizations of 3D nanoarchitectured hBN was conducted. Scanning electron microscopy was employed to inspect the microstructure of the samples. The microstructure of the samples was investigated using a field-emission scanning electron microscope (JEOL JIB-4600F) operated at 15 kV. The hBN sample was loaded on a carbon tape without sputter coating. The high-resolution TEM (HRTEM) images were collected using the Cs-corrected transmission electron microscope Themis Z operated at 80 kV under low-dose mode. The EELS spectrum was collected using the Cs-corrected transmission electron microscope JEOL-ARM300F operated at 300 kV. The optical characterization was conducted using a Horiba LabRAM HR Evolution confocal Raman microscope employing a 532 nm continuous wave (CW) excitation source. Photoluminescence (PL) spectra of hBN quantum emissions were collected with 8 second accumulations, 8 acquisitions and 600 gr/mm grating. The structures of 3D hBN with and without np-Ni substrates were measured by the Raman microscope and the Raman spectra were acquired with 28 second accumulations, 10 acquisitions and 1800 gr/mm grating. Both Raman and PL were collected with a 50× objective lens, NA=0.75 at a laser power of 1.54 milliwatts. Fluorescence maps were produced using 531 nm laser in a fluorescence lifetime imaging microscope (FLIM) system.

Single photon emission was verified by second order autocorrelation measurements, g⁽²⁾(τ) using a Hanbury-Brown Twiss geometry. The measurement was conducted using a Picoquant Microtime 200 confocal microscope employing a 531 nm CW excitation source at Naval Research Laboratory. It should be noted that the wavelength difference between the lasers used in the PL/Raman measurements (532 nm) and in the autocorrelation measurements (531 nm) is minimal and does not affect the conclusions described herein. 532 nm and 600 nm long pass filters were used to remove the excitation laser and Raman spectra. 700 nm short pass filters were placed in front of each detector to mitigate the effects of detector backflash. The emission was collected using a 100× objective lens, NA=0.9, at a laser power of 6.2 microwatts for a duration of 30 minutes. Fitting of the g⁽²⁾(τ) data was done in Python using expression equation 1-ρ²[(1+α)e^{-|τ-τ}^{₀}^{|/τ}^{₁}−ae^{-|τ-τ}^{₀}^{|/τ}^{₂}] which is identical to that given in the main text except for the addition of a τ₀ offset term to account for a path length discrepancy between the two detectors used in the measurement.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A single photon emitter, comprising:
a three-dimensional nanoporous sheet comprising:
hexagonal boron nitride;
a plurality of convex curvatures; and
a plurality of concave curvatures; and wherein:
one or more radii of curvatures of the plurality of convex curvatures are from about 50 nm to about 300 nm; and
one or more radii of curvatures of the plurality of convex curvatures are from about 50 nm to about 300 nm.

2. The single photon emitter of claim 1, wherein the three-dimensional nanoporous sheet is from about 10 to about 50 microns thick.

3. The single photon emitter of claim 1, wherein one or more lateral dimensions of the three-dimensional nanoporous sheet are from about 5 cm to about 50 cm.

4. The single photon emitter of claim 1, wherein a g²(τ) value of the three-dimensional nanoporous sheet is 0.06 or less.

5. The single photon emitter of claim 1, wherein the three-dimensional nanoporous sheet, as characterized by E_{2g} Raman spectroscopy, has a full width at half maximum (FWHM) distribution peak at 15 cm⁻¹.

6. The single photon emitter of claim 1, wherein a mean curvature of the plurality of convex curvatures and the plurality of convex curvatures is zero.

7. The single photon emitter of claim 1, wherein the three-dimensional nanoporous sheet is substrate-free.

8. A method for preparing a three-dimensional nanoporous sheet, comprising:
providing an alloyed substrate, comprising an alloy of a first metal and a second metal;
dealloying the alloyed substrate to selectively remove the second metal from the alloyed substrate to create a dealloyed substrate;
pre-annealing the dealloyed substrate;
growing a layer of hexagonal boron nitride onto one or more internal and external surfaces of the dealloyed substrate; and
etching away the dealloyed substrate to provide a hexagonal boron nitride (hBN) three-dimensional nanoporous sheet.

9. The method for preparing a three-dimensional nanoporous sheet of claim 8, wherein:
the first metal is nickel (Ni);
the second metal is manganese (Mn); and
the second metal is removed from the alloyed substrate using a selective dealloying solution based on a difference in chemical potential between the second metal and the first metal.

10. The method for preparing a three-dimensional nanoporous sheet of claim 8, wherein dealloying the alloyed substrate further comprises exposing the alloyed substrate to a 1M solution of (NH₄)₂SO₄ solution.

11. The method for preparing a three-dimensional nanoporous sheet of claim 8, wherein the second metal is copper (Cu).

12. The method for preparing a three-dimensional nanoporous sheet of claim 8, further comprising stabilizing the dealloyed substrate with a solution coating of a polymer.

13. The method for preparing a three-dimensional nanoporous sheet of claim 12, wherein the polymer comprises polymethyl methacrylate (PMMA).

14. The method for preparing a three-dimensional nanoporous sheet of claim 8, wherein growing a layer of hexagonal boron nitride onto one or more internal and external surfaces of the dealloyed substrate comprises chemical vapor deposition (CVD) at a temperature from about 1000° C. to about 1050° C.

15. The method for preparing a three-dimensional nanoporous sheet of claim 8, wherein one or more lateral dimensions of the hexagonal boron nitride (hBN) three-dimensional nanoporous sheet are from about 5 cm to about 50 cm.

16. The method for preparing a three-dimensional nanoporous sheet of claim 8, wherein the hexagonal boron nitride (hBN) three-dimensional nanoporous sheet is from about 10 to about 50 microns thick.

17. The method for preparing a three-dimensional nanoporous sheet of claim 8, wherein a g²(τ) value of the hexagonal boron nitride (hBN) three-dimensional nanoporous sheet is 0.06 or less.

18. The method for preparing a three-dimensional nanoporous sheet of claim 8, wherein the hexagonal boron nitride (hBN) three-dimensional nanoporous sheet, as characterized by E_{2g} Raman spectroscopy, has a full width at half maximum (FWHM) distribution peak at 15 cm⁻¹.

19. The method for preparing a three-dimensional nanoporous sheet of claim 8, wherein the hexagonal boron nitride (hBN) three-dimensional nanoporous sheet is a single photon emitter.

20. The method for preparing a three-dimensional nanoporous sheet of claim 8, wherein the hexagonal boron nitride (hBN) three-dimensional nanoporous sheet comprises:
a plurality of convex curvatures; and
a plurality of concave curvatures; and wherein:
one or more radii of curvatures of the plurality of convex curvatures are from about 50 nm to about 300 nm;
one or more radii of curvatures of the plurality of convex curvatures are from about 50 nm to about 300 nm; and
a mean curvature of the plurality of convex curvatures and the plurality of convex curvatures is zero.
